(19) United States
(12) Patent Application Publication
(10) Pub. No.: US 2026/0274357 A1
(43) Pub. Date: Sep. 17, 2026

(54) INSPECTION SYSTEM, INSPECTION METHOD, AND METHOD OF MANUFACTURING MOBILE BODY

(71) Applicant: TOYOTA JIDOSHA KABUSHIKI KAISHA, Toyota-shi (JP)

(72) Inventors: Toshihiro KOIDE, Toyota-shi (JP); Takuro SAWANO, Nisshin-shi (JP); Yuhei NAGAFUCHI, Nagakute-shi (JP); Kento IWAHORI, Nagoya-shi (JP)

(73) Assignee: TOYOTA JIDOSHA KABUSHIKI KAISHA, Toyota-shi (JP)

(21) Appl. No.: 19/563,140

(22) Filed: Mar. 11, 2026

(30) Foreign Application Priority Data
Mar. 13, 2025 (JP) 2025-040627

(51) Int. Cl. B62D 65/00; B62D 65/18; G01M 17/007; G07C 5/04

(52) U.S. Cl. CPC B62D 65/005; B62D 65/18; G01M 17/007; G07C 5/04

(57) ABSTRACT

Provided are an inspection system, an inspection method, and a method for manufacturing a mobile body each adapted to improve uniformity of inspection conditions. According to the present disclosure, an inspection system includes a vehicle control unit, a recorded data acquisition unit, and an anomalous sound detection unit. The vehicle control unit is configured to control the traveling operation of the vehicle. The recorded data acquisition unit is configured to acquire recorded data recorded inside a vehicle that is traveling based on control performed by the vehicle control unit. An anomalous sound detection unit is configured to detect an abnormal sound, which is a sound associated with an abnormality of the vehicle from the recorded data.

### CROSS REFERENCE TO RELATED APPLICATIONS

This application is based upon and claims the benefit of priority from Japanese patent application No. 2025-040627, filed on Mar. 13, 2025, the disclosure of which is incorporated herein in its entirety by reference.

### BACKGROUND

The present disclosure relates to an inspection system, an inspection method, and a method of manufacturing a mobile body.

Patent Literature 1 discloses a sound control method for a vehicle equipped with a noise canceling apparatus for reducing noise in a vehicle cabin. In the sound control method described in Patent Literature 1, it is determined whether or not a management-and-repair personnel involved in management or repair of a vehicle is included in the vehicle occupant. In the sound control method described in Patent Literature 1, in case where a management-and-repair personnel is included in the vehicle occupant, the noise reducing action of the noise canceling apparatus is stopped or reduced.

[Patent Literature 1] Japanese Unexamined Patent Application Publication No. 2023-173428

### SUMMARY

In the case where vehicle anomalous sound inspection is performed, the anomalous sound generated from the vehicle is affected by the traveling operation of the vehicle. If there is a variation in the traveling operation of a vehicle, there is also a variation in the way the anomalous sound is heard.

In an inspection process such as the anomalous sound inspection, it is preferable that the conditions affecting the inspection process are unified as much as possible. However, as in the case of Patent Literature 1, in the case where the anomalous sound inspection is performed while an operator is driving the vehicle, variation occurs in the traveling operation of vehicles, and the conditions cannot be said to be sufficiently unified.

That is, in the anomalous sound inspection in the prior art, there is a problem that the anomalous sound cannot be inspected under the same conditions.

It is an object of the present disclosure to solve these problems, and to provide an inspection system, an inspection method, and a mobile body manufacturing method each adapted to improve uniformity of inspection conditions.

An inspection system according to the present disclosure includes a mobile body control unit, a recorded data acquisition unit, and an anomalous sound detection unit. The mobile body control unit is configured to control a moving operation of the mobile body. The recorded data acquisition unit is configured to acquire recorded data recorded inside the mobile body that is moving based on control performed by the mobile body control unit. The anomalous sound detection unit is configured to detect an abnormal sound, which is a sound associated with an abnormality of the mobile body, from the recorded data.

In the inspection system according to the present disclosure, the mobile body control unit may control a plurality of mobile bodies so as to move the plurality of mobile bodies along the same route at the same speed.

In an inspection method according to the present disclosure, recorded data recorded inside a mobile body that is moving based on control performed by a computer apparatus is acquired. Then, from the recorded data, an anomalous sound which is a sound associated with an abnormality of the mobile body is detected.

A method for manufacturing a mobile body according to the present disclosure includes: acquiring recorded data recorded inside a mobile body that is traveling based on control performed by a computer apparatus; and detecting an anomalous sound, which is a sound associated with an abnormality of the mobile body , from the recorded data. In the case where the abnormal sound is not detected, the computer apparatus performs control to make the vehicle move to a predetermined position at which a next manufacturing process is performed.

In accordance with the present disclosure, it is possible to provide an inspection system, an inspection method, and a mobile body manufacturing method each adapted to improve uniformity of inspection conditions.

The above and other objects, features and advantages of the present disclosure will become more fully understood from the detailed description given hereinbelow and the accompanying drawings.

### BRIEF DESCRIPTION OF DRAWINGS

FIG. 1 is a schematic overhead view showing a configuration of a mobile body control system according to a first embodiment;

FIG. 2 is a block diagram showing a configuration of a server according to the first embodiment;

FIG. 3 is a block diagram showing a configuration of the server according to the first embodiment; and

FIG. 4 is a flowchart showing an operation of the server according to the first embodiment.

### DESCRIPTION OF EMBODIMENTS

### First Embodiment

### Configuration of Inspection System

Hereinafter, a first embodiment according to the present disclosure will be described in detail with reference to the drawings. First, a configuration of a detection system according to this embodiment will be described in detail.

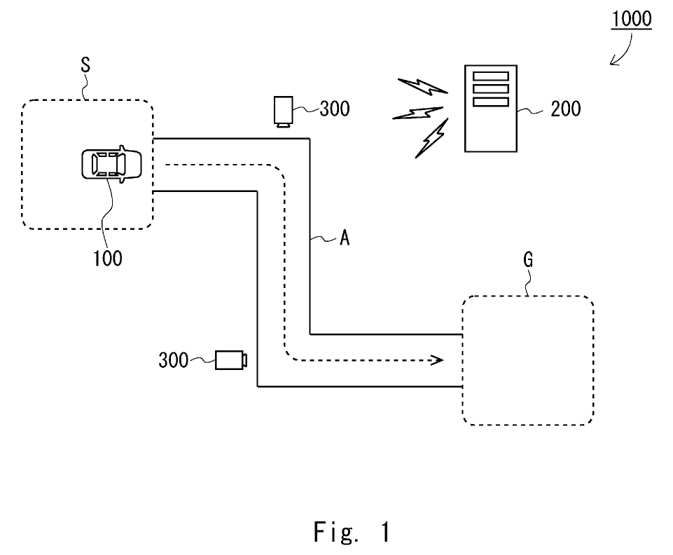

FIG. 1 is a schematic an overhead view showing a configuration of a mobile body control system according to the first embodiment.

An inspection system according to the first embodiment is implemented as a part of a mobile body control system 1000. The mobile body control system 1000 is configured to control the movement of mobile bodies. More specifically, the mobile body control system 1000 according to the first embodiment is configured to control the operation performed by a vehicle 100 shown in FIG. 1.

Note that in the present disclosure, the “mobile body” means an object that can move, and is, for example, a vehicle or an electric vertical take-off and landing aircraft (so-called a flying vehicle). The vehicle may be a vehicle that travels on wheels or by an endless track. For example, the vehicle is a passenger car, a truck, a bus, a two-wheeled vehicle, a four-wheeled vehicle, a tank, a construction vehicle, or the like. Examples of vehicles include a battery electric vehicle (BEV: Battery Electric Vehicle), a gasoline vehicle, a hybrid vehicle, and a fuel cell vehicle. When the mobile body is an object other than the vehicle, the terms “vehicle” or “car” in the present disclosure may be replaced with “mobile body” as appropriate, and the term “traveling” may be replaced with “moving” as appropriate. Thus, for example, a traveling operation described later may be called a moving operation, and a vehicle control unit described later may be called a mobile body control unit.

The mobile body control system 1000 according to this embodiment controls the operation performed by the vehicle 100 shown in FIG. 1 to make the vehicle 100 travel from a departure point S to a destination point G. More specifically, the mobile body control system 1000 according to this embodiment makes the vehicle 100 move from the departure point S to the destination point G by making the vehicle 100 travel in an area A.

The mobile body control system 1000 according to this embodiment may be introduced into a vehicle manufacturing factory, or may be used to control the movement of the vehicle 100 during manufacturing.

In this case, the departure point S and the destination point G according to this embodiment are workplaces for performing various manufacturing processes on the vehicle 100. In contrast to the departure point S, the destination point G may be referred to as a “predetermined position at which the next manufacturing process is executed”.

It should be noted that the “vehicle during manufacturing” as used herein may refer to a vehicle in a state where all assembly as a product is not completed, or a vehicle in a state where all assembly as a product is completed but inspection necessary for shipment is not completed.

The “manufacturing process” as used herein may include not only an assembly process and a processing process of vehicles, but also an inspection process after assembly is completed.

However, the application of the mobile body control system 1000 according to the present disclosure is not limited to the above. For example, the mobile body control system according to the present disclosure may be used to convey a plurality of vehicles manufactured in a vehicle manufacturing factory to a yard. Further, the mobile body control system according to the present disclosure may also be used to load a plurality of vehicles onto a ship or a freight train.

Although the details will be described later, the inspection system according to this embodiment detects an anomalous sound which is a sound associated with an abnormality of the vehicle 100 at a timing when the vehicle 100 is moving in the area A. Here, the expression “detecting an anomalous sound” includes an attempt to detect an anomalous sound.

The mobile body control system 1000 may make the vehicle 100 move to the destination point G in the case where no anomalous sound is detected by the detection system according to this embodiment.

Further, the mobile body control system 1000 may make the vehicle 100 move to a point different from the destination point G in the case where the anomalous sound is detected by the detection system according to this embodiment. That is, the mobile body control system 1000 may change the destination point of the vehicle 100 in the case where the anomalous sound is detected at a timing when the vehicle 100 is made to move to the destination point G.

The mobile body control system 1000 according to this embodiment includes a server 200, and an external sensor 300.

In the mobile body control system 1000, the server 200 acquires observation information of the area A from the external sensor 300 and controls the operation performed by the vehicle 100 based on the observation result. Then, the server 200 detects an anomalous sound generated in the vehicle 100.

That is, the detection system according to this embodiment is implemented as the server 200.

As described above, the detection system according to this embodiment is implemented by the server 200, i.e., a computer configured as a single apparatus. However, the configuration of the position detection system according to the present disclosure is not limited to the above, and may be configured of two or more apparatuses.

The external sensor 300 is a sensor located outside the vehicle 100. The external sensor 300 includes a communication apparatus and can communicate with other apparatuses such as the server 200 by wired communication or wireless communication.

More specifically, the external sensor 300 according to this embodiment is a sensor for observing a movement region A in which mobile bodies move. The external sensor 300 transmits the observation information as the observation result of the movement region A to the server 200.

Specifically, the external sensor 300 is formed by a camera. The camera, which serves as the external sensor 300, takes a photograph image of the movement region A, and outputs the photograph image as observation information.

However, the external sensor 300 according to this embodiment is not limited to a camera, and may be, for example, a LiDAR (Light Detection And Ranging). In this case, the detection result output by the external sensor 300 may be three-dimensional point cloud data of the movement region A.

That is, the external sensor 300 according to this embodiment may be any sensor capable of outputting information usable for detecting position information of a vehicle by observing the movement region A.

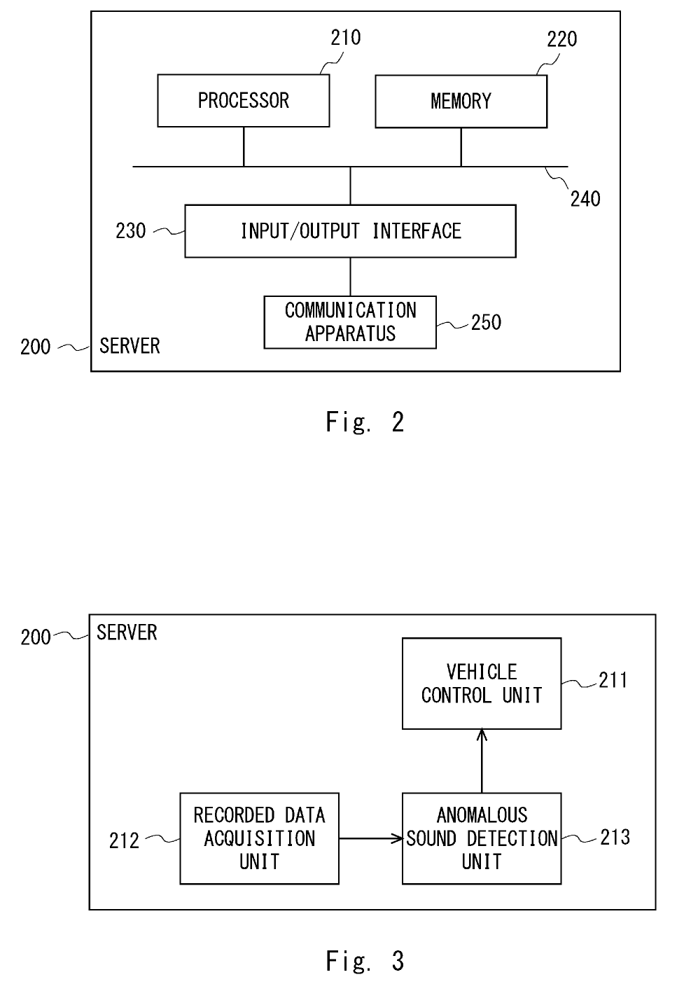

FIG. 2 is a block diagram showing the configuration of the server according to the first embodiment.

The server 200 is configured of a computer including a processor 210, a memory 220, an input/output interface 230, and an internal bus 240.

The processor 210, the memory 220, and the input/output interface 230 are bidirectionally connected to each other through the internal bus 240 so that they can communicate with each other.

A communication apparatus 250 for communicating with various apparatuses located outside the server 200 is connected to the input/output interface 230.

The communication apparatus 250 can communicate with the vehicle 100 by wireless communication, and can communicate with each external sensor 300 and each recording apparatus 400 by wired communication or by wireless communication.

The processor 210 implements various functions including functions as a vehicle control unit 211, a recorded data acquisition unit 212, and an anomalous sound detection unit 213 by executing the programs stored in the memory 220.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The vehicle control unit 211 controls the traveling operation of the vehicle 100.

More specifically, the vehicle control unit 211 according to this embodiment controls a plurality of vehicles 100 so that the plurality of vehicles 100 travel along a predetermined route at a predetermined speed.

The vehicle control unit 211 according to this embodiment is realized as a function of the server 200 which is a computer apparatus. Therefore, in the case where traveling of the vehicle 100 is controlled by the vehicle control unit 211, variation in the traveling operation of the vehicles 100 is suppressed as compared with the case where traveling of a vehicle 100 is controlled by the driving operation performed by a worker.

Although the details will be described later, the inspection system according to this embodiment detects the anomalous sound generated in a vehicle 100 that is traveling based on control performed by the vehicle control unit 211.

That is, the inspection system according to this embodiment detects the anomalous sound in a vehicle 100 in a state where the variation in the traveling operation is suppressed. According to such a configuration, the vehicle 100 according to the present embodiment is adapted to improve uniformity of inspection conditions.

The vehicle control unit 211 acquires the detection result of the anomalous sound from the anomalous sound detection unit 213. The vehicle control unit 211 controls the operation performed by the vehicle 100 based on the detection result of the anomalous sound.

More specifically, in the case where no anomalous sound is detected, the vehicle control unit 211 makes the vehicle 100 move to the destination point G. In the case where an anomalous sound is detected, the vehicle control unit 211 causes the vehicle 100 to perform an emergency operation.

It should be noted that an “emergency operation” herein refers to an operation for dealing with the detected anomalous sound. For example, an emergency operation may be an operation of stopping the vehicle 100 from traveling. Further, for example, an emergency operation may change the destination point of the vehicle 100 and make the vehicle 100 travel to the changed destination point.

The changed destination point herein is, for example, a place where maintenance of the vehicle 100 is performed. In the changed destination point, it is preferable that the cause of the anomalous sound is identified in the vehicle 100 and that the identified cause of the anomalous sound is appropriately treated.

Hereinafter, a mode in which the vehicle control unit 211 controls the operation of the vehicle 100 will be described in more detail.

The vehicle control unit 211 acquires observation information from the external sensor 300. The vehicle control unit 211 detects position information of mobile bodies based on the observation information. More specifically, the vehicle control unit 211 detects the contour of a vehicle 100 from photograph image acquired as observation information, and calculates coordinates of the positioning point of the vehicle 100 in the coordinate system of the photograph image, i.e., the local coordinate system. The vehicle control unit 211 converts the calculated local coordinates into coordinates in the global coordinate system, thereby detecting position information of the vehicle 100.

The contour of the vehicle 100 shown in the photograph image may be detected, for example, by inputting the photograph image into a detection model using artificial intelligence.

That is, the vehicle control unit 211 according to this embodiment may detect position information of the vehicle 100 by inputting the acquired observation information to the artificial intelligence model which uses observation information as input information and outputs position information of the mobile body.

Examples of the detection model include, for example, a trained machine learning model that has been trained to implement either semantic segmentation or instance segmentation. As this machine learning model, for example, a convolutional neural network (hereinafter also referred to as a CNN) that has been trained by supervised learning using a learning data set may be used. The learning data set includes, for example, a plurality of training images including vehicles 100, and labels each of which indicates whether a respective area in training images is an area indicating a vehicle 100 or an area other than the vehicle 100. When the CNN is trained, parameters of the CNN are preferably updated so as to reduce errors between output results of the detection model and the labels by back-propagation (error back-propagation method). Further, the vehicle control unit 211 may acquire the direction of the vehicle 100 by, for example, estimating it based on the direction of the movement vector of the vehicle 100 calculated from the positional changes of the feature points of the vehicle 100 between frames of the photograph image by using an optical flow method.

The vehicle control unit 211 determines a destination position to which the vehicle 100 should travel next. The destination position is represented by, for example, coordinates of X, Y, and Z in the global coordinate system. In the vehicle control unit 211, a reference route which is a route along which the vehicle 100 should travel is previously stored. The route is represented by a node representing a place of departure, a node representing a transit point, a node representing a final destination, and a link connecting the nodes. The vehicle control unit 211 determines the destination position to which the vehicle 100 should travel next by using the vehicle position information and the reference route. The vehicle control unit 211 determines the destination position on the reference route ahead of the current location of the vehicle 100.

The vehicle control unit 211 generates a travel control signal for making the vehicle 100 travel toward the determined destination position. The vehicle control unit 211 calculates the traveling speed of the vehicle 100 from the transition of the position of the vehicle 100, and compares the calculated traveling speed with the target speed.

The vehicle control unit 211 determines acceleration so that the vehicle 100 accelerates in the case where the traveling speed is lower than the target speed as a whole, and determines acceleration so that the vehicle 100 decelerates in the case where the traveling speed is higher than the target speed.

The vehicle control unit 211 determines the steering angle and the acceleration of the vehicle 100 so that the vehicle 100 does not deviate from the reference route in the case where the vehicle 100 is located on the reference route, and determines the steering angle and the acceleration so that the vehicle 100 returns on the reference route in the case where the vehicle 100 is not located on the reference route, that is, in the case where the vehicle 100 deviates from the reference route.

The vehicle control unit 211 transmits the generated travel control signal to the vehicle 100. The vehicle control unit 211 repeats acquisition of the position of the vehicle 100, determination of the destination position, generation of a travel control signal, transmission of the travel control signal, and the like at a predetermined cycle.

The vehicle 100 receives the travel control signal transmitted from the server 200. The vehicle 100 controls an actuator group by using the received travel control signal, thereby making the vehicle 100 travel at the acceleration and the steering angle represented by the travel control signal. The vehicle 100 repeats reception of the travel control signal and control of the actuator group at a predetermined cycle.

The description of FIG. 3 is referred to again.

The recorded data acquisition unit 212 acquires the recorded data recorded inside the vehicle 100 which is traveling based on control performed by the vehicle control unit 211. The recorded data acquisition unit 212 outputs the acquired recorded data to the anomalous sound detection unit 213.

The recorded data acquisition unit 212 may acquire recorded data from, for example, a recording apparatus installed in the vehicle 100, or may acquire recorded data from a recording apparatus configured as an apparatus independent of the vehicle 100.

In the case where the recording apparatus according to this embodiment is a recording apparatus installed in the vehicle 100, the server 200 executes wireless communication with the vehicle 100 to acquire recorded data.

In the case where the speaker apparatus according to this embodiment is an apparatus independent of the vehicle 100, the server 200 executes wireless communication with the recording apparatus to acquire recorded data.

The anomalous sound detection unit 213 acquires recorded data from the recorded data acquisition unit 212. The anomalous sound detection unit 213 detects an anomalous sound, which is a sound associated with abnormality of a vehicle, from the recorded data. The anomalous sound detection unit 213 outputs the detection result of the anomalous sound to the vehicle control unit 211.

More specifically, the anomalous sound detection unit 213 according to this embodiment detects an anomalous sound generated in a vehicle 100 which is traveling based on control performed by the vehicle control unit 211. That is, the anomalous sound detection unit 213 according to this embodiment detects an anomalous sound generated in a vehicle 100 which is under a state in which variation in traveling operation is suppressed. With such a configuration, the vehicle 100 according to this embodiment is adapted to improve uniformity of inspection conditions.

Note that as described above, the expression “detecting an anomalous sound” herein includes an attempt to detect an anomalous sound. That is, the expression “detecting an anomalous sound” herein may refer to checking whether a sound corresponding to an anomalous sound is included in the acquired recorded data.

Note that the anomalous sound detection unit 213 according to this embodiment outputs the detection result of the anomalous sound to the vehicle control unit 211, but the configuration of the anomalous sound detection system according to the present disclosure is not limited to this configuration. For example, the anomalous sound detection unit 213 according to the present disclosure may notify the user of the detection result of the anomalous sound.

The anomalous sound detection unit 213 according to this embodiment may be configured to output the detection result in the case where the anomalous sound is detected and may be configured not to output the detection result in the case where the anomalous sound is not detected, for example. The anomalous sound detection unit 213 according to this embodiment may output the detection result of both the case where the anomalous sound is detected and the case where the anomalous sound is not detected, for example.

That is, the anomalous sound detection unit 213 according to this embodiment may output a detection result at least in the case where an anomalous sound is detected.

As described above, the inspection system according to this embodiment causes the vehicle 100 to travel based on control performed by the vehicle control unit 211 implemented as a computer apparatus. Then, the inspection system according to this embodiment detects an abnormal sound from the recorded data recorded inside the vehicle 100 that is traveling.

According to this configuration, the inspection system according to this embodiment can record sound inside the vehicle 100 while suppressing the variation in the traveling operation of the vehicle 100. As a result, the inspection system according to this embodiment is adapted to improve the uniformity of inspection conditions.

### Manufacturing Method of Vehicles

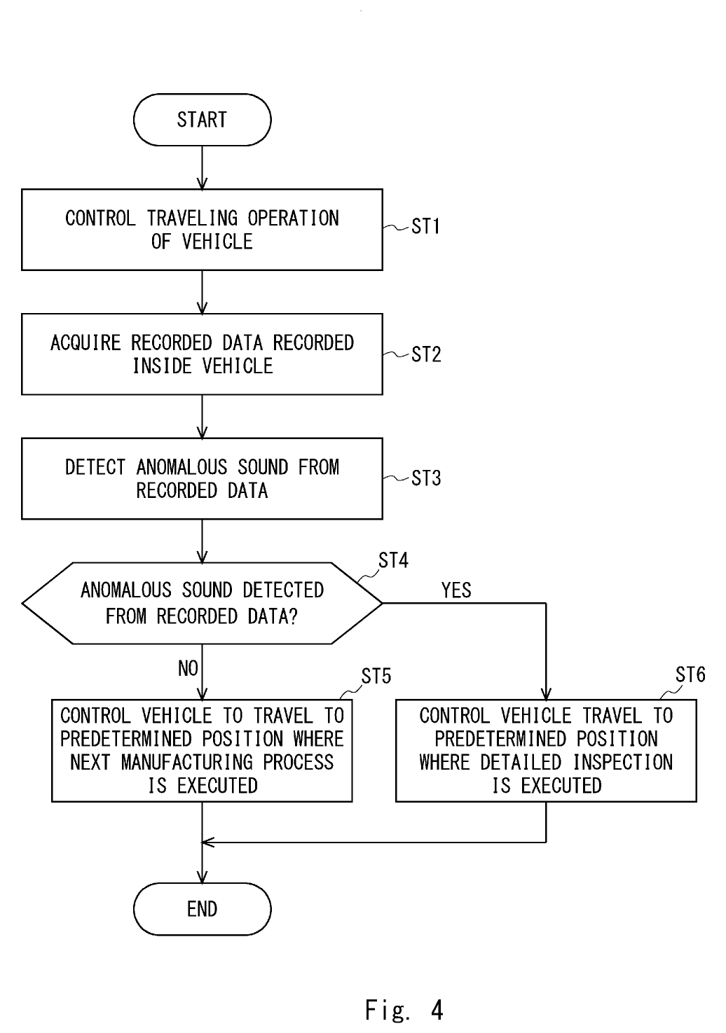

Next, a method for manufacturing a mobile body according to the first embodiment will be described in detail. FIG. 4 is a flowchart showing an operation of the method for manufacturing a mobile body according to the first embodiment. Note that in the following description, FIGS. 1 to 3 will be referred to as appropriate.

In the processing procedure of FIG. 4, the processor 210 of the server 200 functions as the vehicle control unit 211, the recorded data acquisition unit 212 and the anomalous sound detection unit 213 by reading out and executing a program stored in the memory 220.

In the method for manufacturing a mobile body according to this embodiment, first, the processor 210 controls traveling operation of a vehicle 100 (Step ST1). That is, in Step ST1, the processor 210 functions as the vehicle control unit 211.

More specifically, in Step ST1, the processor 210 controls the vehicle 100 to travel from the departure point S to the destination point G shown in FIG. 1.

Next, the processor 210 acquires the recorded data recorded inside the vehicle 100 that is traveling (Step ST2). That is, in step ST2, the processor 210 functions as the recorded data acquisition unit 212.

More specifically, in Step ST2, the processor 210 acquires the recorded data recorded inside the vehicle 100 that is traveling based on control performed by the server 200.

That is, in Step ST2, the processor 210 acquires the recorded data recorded inside the vehicle 100 that is traveling based on control performed by the computer apparatus.

Next, the processor 210 detects an anomalous sound, which is a sound associated with abnormality of a vehicle, from the recorded data (Step ST3). That is, in step ST3, the processor 210 functions as the anomalous sound detection unit 213.

Note that the operations from Step ST1 to Step ST3 may be referred to as the inspection method according to the present embodiment.

In Step ST3, the processor 210 detects an anomalous sound from the recorded data recorded inside the vehicle 100 in which variation in the traveling operation is suppressed. With such a configuration, the inspection method according to the present embodiment is adapted to improve the uniformity of inspection conditions.

Next, in Step ST3, the processor 210 determines whether or not an anomalous sound is detected (Step ST4). That is, in Step ST4, the processor 210 functions as the vehicle control unit 211.

In the case where no anomalous sound is detected (Step ST4 NO), the processor 210 controls the vehicle 100 to travel to a predetermined position where the next manufacturing process is executed (Step ST5), and the server 200 according to this embodiment ends a series of operations. That is, in Step ST5, the processor 210 functions as the vehicle control unit 211.

More specifically, in Step ST5, the server 200 according to this embodiment controls the operation of the vehicle 100 so that the vehicle 100 travels to the destination point G.

In the case where an anomalous sound is detected (Step ST4 YES), the processor 210 controls the vehicle 100 to travel to a predetermined position where a detailed inspection is executed (Step ST6), and the server 200 according to this embodiment ends a series of operations. That is, in Step ST6, the processor 210 functions as the vehicle control unit 211.

In other words, in Step ST6, the server 200 according to this embodiment changes the destination point of the vehicle 100 and controls the vehicle 100 to travel to the changed destination point.

As described above, in the method for manufacturing a mobile body according to this embodiment, the vehicle is controlled based on the detection result of an anomalous sound. With this configuration, the vehicle manufacturing method according to this embodiment can improve the quality of the manufactured vehicles.

As described above, in the inspection method according to the this embodiment, the recorded data recorded inside the vehicle 100 that is traveling based on control performed by a computer apparatus is acquired, that is, the server 200, and the anomalous sound is detected from the acquired recorded data.

With this configuration, the inspection method according to this embodiment can execute anomalous sound inspection of a vehicle 100 while suppressing variation in the traveling operation. As a result, the inspection method according to this embodiment is adapted to improve uniformity of the inspection conditions.

Further, in the method for manufacturing a mobile body according to this embodiment, a vehicle is made to move to either a predetermined position where the next manufacturing process is executed or a predetermined position where a detailed inspection is executed based on the detection result of the anomalous sound obtained by using the inspection method described above. As a result, the method for manufacturing a mobile body according to this embodiment can improve the quality of vehicles.

### Other Embodiment

### Other Embodiment 1

In the above-described first embodiment, the server 200 performs processes from obtaining vehicle position information to generating a travel control signal. In contrast, at least some of the processes from acquiring vehicle position information to generating a travel control signal may be executed by the vehicle 100. For example, Forms (1) to (3) described below may be adopted.

(1) The server 200 may detect position information of the vehicle 100, determine a destination position to which the vehicle 100 should travel next, and generate a route from the current position of the vehicle 100 indicated in the detected vehicle position information to the destination position. The server 200 may generate a route to a destination position located between the current location and the final destination, or a route to the final destination. The server 200 may transmit the generated route to the vehicle 100. The vehicle 100 may generate a travel control signal so as to travel along the route received from the server 200, and control the actuator group by using the generated travel control signal.

(2) The server 200 may detect position information of the vehicles 100, and transmit the detected vehicle position information to the vehicles 100. The vehicle 100 may determine a destination position to which the vehicle 100 should travel next, generate a route from the current location of vehicle 100 indicated in the received vehicle position information to the destination position, generate a travel control signal so as to travel along the generated route, and control the actuator group using the generated travel control signal.

(3) In the above-described Forms (1) and (2), the vehicle 100 may include an internal sensor mounted thereon, and a detection result output from the internal sensor may be used for at least one of the generation of a route and the generation of a travel control signal. The internal sensor is a sensor mounted on the vehicle 100. Examples of internal sensors may include a sensor for detecting a motion state of the vehicle 100, a sensor for detecting an operation state of each part of the vehicle 100, and a sensor for detecting an environment around the vehicle 100. Specifically, examples of the internal sensor may include a camera, a LiDAR, a millimeter-wave radar, an ultrasonic sensor, a GPS sensor, an acceleration sensor, and a gyroscopic sensor. For example, in the above-described Form (1), server 200 may acquire a detection result of the internal sensor, and take the acquired detection result of the internal sensor for a route in generating a route. In the above-described Form (1), the vehicle 100 may acquire a detection result of the internal sensor and take the detection result of the internal sensor into consideration for a travel control signal in generating a travel control signal. In the above-described Form (2), the vehicle 100 may acquire a detection result of the internal sensor, and take the detection result of the internal sensor into consideration for a route in generating a route. In the above-described Form (2), the vehicle 100 may acquire a detection result of the internal sensor, and take the acquired detection result of the internal sensor into consideration for a travel control signal in generating a travel control signal.

### Other Embodiment 2

In the above-described first embodiment, the vehicle 100 may include an internal sensor mounted thereon. Further, the vehicle control apparatus may acquire a detection result of the internal sensor, detect current position information of the vehicle 100 based on the acquired detection result, and output a control parameter(s) based on the detected current position information. That is, the position inspection system according to the present disclosure may be a system installed in a vehicle 100.

### Other Embodiment 3

In the above-described first embodiment, a control parameter(s) may be output based on both the detection result of the internal sensor described in Other Embodiment 3 and the detection result of external sensor described in Other Embodiment 3.

### Note

Transporting the vehicle 100 using the traveling of vehicle 100 by unmanned driving is also referred to as “self-propelled conveyance”. A configuration for realizing self-propelled conveyance is also referred to as a “vehicle remote control autonomous conveyance system”. A production system for producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

While the present disclosure has been described with reference to the above-described embodiments, the present disclosure is not limited to the configuration of the above-described embodiments, and various changes, modifications, or combinations may be made by a person skilled in the art within the scope of the claimed disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An inspection system, comprising:
a mobile body control unit configured to control a moving operation of a mobile body;
a recorded data acquisition unit configured to acquire recorded data recorded inside the mobile body that is moving based on control performed by the mobile body control unit; and
an anomalous sound detection unit configured to detect an anomalous sound, which is a sound associated with an abnormality of the mobile body, from the recorded data.

2. The inspection system according to claim 1, wherein the mobile body control unit is configured to control the mobile body so that a plurality of the mobile bodies move along a predetermined route at a predetermined speed.

3. An inspection method comprising:
acquiring recorded data recorded inside a mobile body that is moving based on control performed by a computer apparatus; and
detecting an anomalous sound, which is a sound associated with an abnormality of the mobile body, from the recorded data.

4. A method for manufacturing a mobile body, comprising:
acquiring recorded data recorded inside a mobile body that is traveling based on control performed by a computer apparatus;
detecting an anomalous sound, which is a sound associated with an abnormality of the mobile body, from the recorded data; and
performing control by the computer apparatus to make the vehicle move to a predetermined position at which a next manufacturing process is performed in the case where the abnormal sound is not detected from the recorded data.
